(19) United States
(12) Patent Application Publication
(10) Pub. No.: US 2011/0119741 A1
(43) Pub. Date: May 19, 2011

(54) Method for Conditionally Obtaining Files From a Local Appliance

(75) Inventors: Matthew Kelly, San Jose, CA (US); Edward Fields, Los Gatos, CA (US)

(73) Assignee: Hotchalk Inc., Campbell, CA (US)

(21) Appl. No.: 12/621,446

(22) Filed: Nov. 18, 2009

(51) Int. Cl. H04L 9/32

(52) U.S. Cl. 726/5

(57) ABSTRACT

The invention is directed to a method for allowing a user at a client device to conditionally obtain files from either a server device located at, for example, a data center, or an appliance such as a local cache. Should the local appliance be accessible by the client at the time of the user's download request, the server may redirect the download request to the appliance. Otherwise, the file may be downloaded directly from the server. For example, a method configured according to the invention may receive, at a server device, login data from a client device, the login data being input by a user. An affiliated entity of the user based on the login data may be determined, after which an appliance status of the affiliated entity may be determined. A download process according to the appliance status may then be initiated.

### BACKGROUND OF THE INVENTION

Files for distribution may often be stored on central servers of a company, internet business, or other organization. These servers may be housed at a remote data center and configured to be accessible over the organization's data network. However, delivery of large files from data centers may be slow or delayed, especially during peak usage periods. For example, a school teacher may wish to download files from the remote central server of an educational resources company. The download speed may be limited by server bandwidth, especially at busy times such as lunch hour, when teachers from various schools and campuses are requesting downloads. Delays in accessing important data can often hinder productivity and disrupt the workflow of an organization.

One solution to this problem may involve local caching of files, but this is limited by the accessibility of the caching server by a client. For example, a teacher on a school campus may be able to access a local cache from her laptop computer to obtain files, if the cache is located on campus. When she returns home in the evening, she may need to obtain certain files to prepare lesson plans for the next school day, but may no longer be able to access the cache because she is off-campus.

Thus, neither downloading scheme allows for both flexibility of access from various client locations, as well as accelerated download speed. Hence, it is desirable to have a solution without the above-described disadvantages. As will be seen, the invention provides such a solution in an elegant manner.

### BRIEF DESCRIPTION OF THE DRAWINGS

FIG. 1 illustrates an embodiment of the invention.

FIG. 2 illustrates another embodiment of the invention.

FIGS. 3A-F illustrate another embodiment of the invention.

FIG. 4 illustrates another embodiment of the invention.

FIG. 5 illustrates another embodiment of the invention.

FIG. 6 illustrates another embodiment of the invention.

FIG. 7 illustrates another embodiment of the invention.

### DETAILED DESCRIPTION OF THE INVENTION

The invention is directed to a method for allowing a user at a client device to conditionally obtain files from a server device located at, for example, a data center, or from an appliance such as a local cache. Should the local appliance be accessible by the client at the time of the user's download request, the server may redirect the download request to the appliance. Otherwise, the file may be downloaded directly from the server.

For example, according to one embodiment of the invention, a server device may receive login data from a client device, the login data having been input by a user. An affiliated entity of the user may be determined based on the login data, after which an appliance status of the affiliated entity may be determined. A download process according to the appliance status may then be initiated.

According to another embodiment, a client device may receive login data input by a user and transmit the login data to a server device. A request for an access status may then be received from the server along with an appliance IP address. Once the access status is determined, it may be sent to the server.

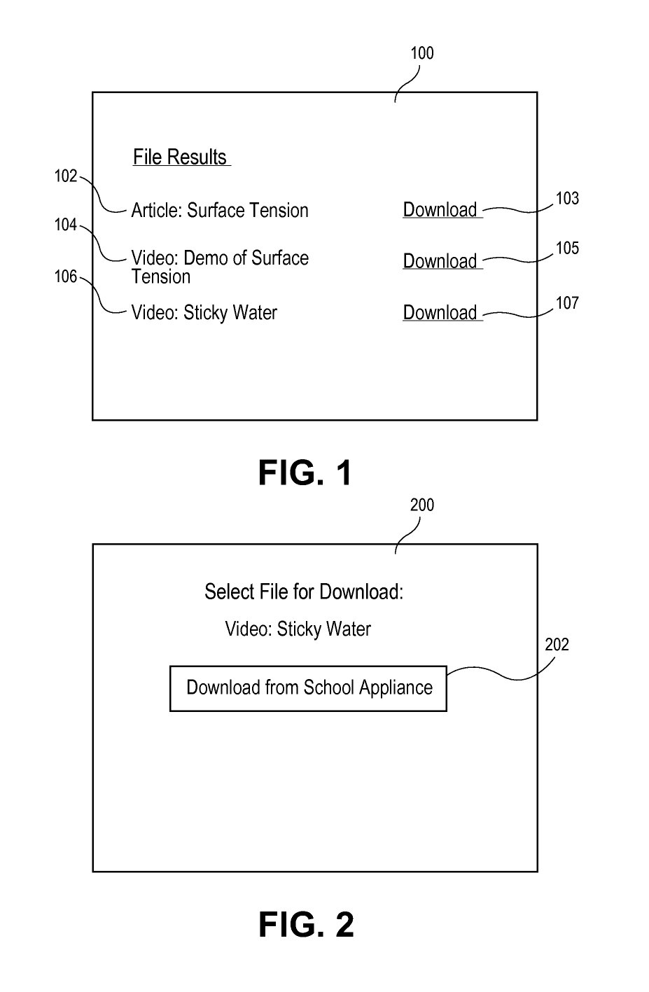

As an example, file selection page 100 is shown in FIG. 1. This page 100 may appear in response to, for instance, a user-input search or other action via a client device. Page 100 may be hosted by a server device. Available files 102/104/106 may be selected for download by the user clicking on links 103/105/107. Upon the user selecting one of the links, for instance, 107, the user may be taken to download page 200 of FIG. 2. Download button 202 may be selected by the user in order to initiate the download process. The appearance of button 202 may be based on the appliance status as determined, for instance, in the process described below. For instance, button 202 as illustrated in FIG. 2 reads, “Download from School Appliance.” This may indicate, for instance, the accessibility of a school appliance such as a local cache by the client device. Likewise, should it be determined that no local appliance is available or accessible, button 202 may read “Download from Central Server” or something similar.

Alternatively, button 202 may forego any indication of where the download is to occur from. Rather, the button 202 may simply read “Download File” or another generic phrase. Upon user selection, the download process may be initiated from either a local appliance or a central server, based on whether a local appliance has been determined to be accessible.

In an alternative embodiment, should the local appliance be determined to be accessible, the user interface may offer one option to “Download from School Appliance” and another option to “Download from Central Server.” This may allow the user to return to the page to make another download attempt from the server if the initially attempted download from the school appliance fails.

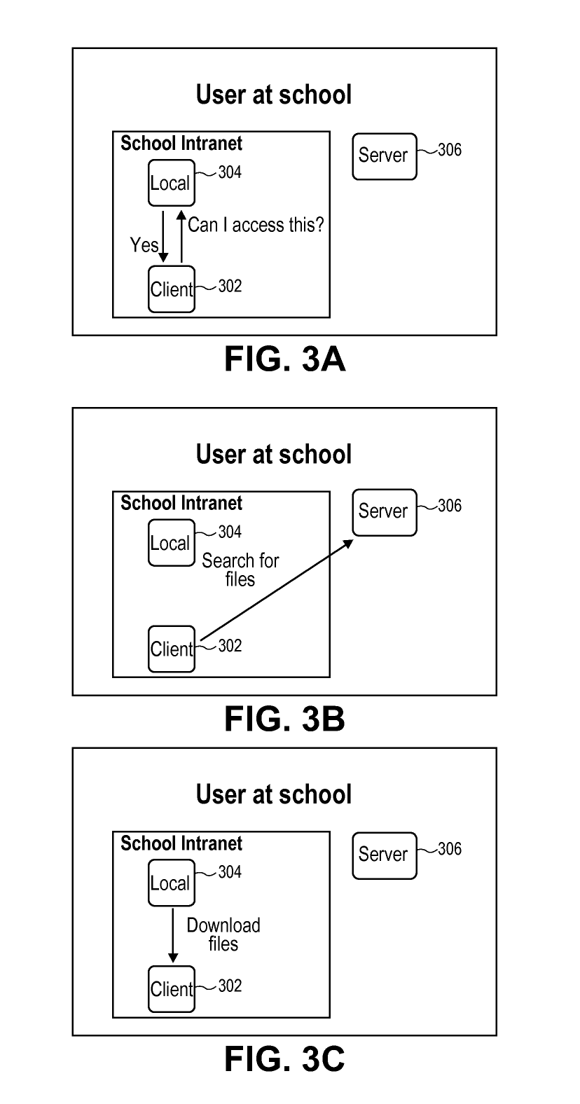

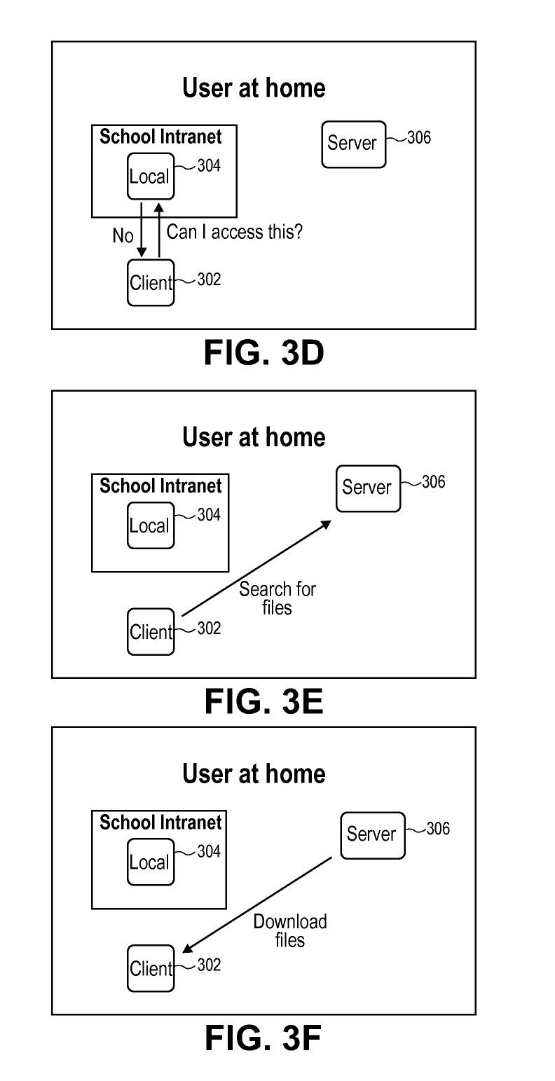

FIGS. 3A-C and 3D-F illustrate examples of conditionally downloading based on accessibility of a client to a local appliance. In the embodiment depicted in these figures, a user such as a teacher attempts to download files from a client computer 302 on a school campus in FIGS. 3A-C, in contrast to downloading from a client computer 302 at a remote location, such as the teacher's home, in FIGS. 3D-F. In FIG. 3A, when the user is at school, the client 302 receives the user's request for a download and communicates this request to the server 306. Upon receiving the user request, server 306 may determine, for example, that the user's school has purchased an appliance 304 for caching files locally. In this case, the server 306 may send to the client 302 a request with the IP address of the appliance 304. Client 302 may then attempt to access local appliance 304 using the given IP address; if the access attempt is successful, the client 302 may indicate to server 306 a positive appliance status.

As shown in FIG. 3B, the server 306 may then process a search for files based on previously input parameters from the user. The server my access a local cache and search for files stored in the cache or other storage. The cache may be updated from time to time based on predetermined criteria. Those skilled in the art will understand that such functions are well known and adaptable to a system configured according to the invention. The local cache may also be a network cache or local area network (LAN) cache, which may or may not be on or peripheral to the user's local machine. Upon locating the requested files, server 306 may redirect the user to download the files from the local cache 304, as in FIG. 3C. In an alternative embodiment, this search may occur prior to determination of the client's ability to access a local appliance. The search results may be displayed to the user via client 302, in response to which the user may then select a file for download. The local appliance accessibility may be determined at that point, and the server 302 may redirect the user to proceed accordingly, in a manner such as but not limited to that described above with regard to download button 202 of FIG. 2.

If, however, server 306 determines that the school has not purchased a locally accessible appliance, or if client 302 is unable to access appliance 304 as illustrated in FIG. 3D, the download process may proceed without the involvement of appliance 304, as shown in FIGS. 3E-F. The server 306 searches for files (FIG. 3E), after which the download process is initiated via the server itself (FIG. 3F).

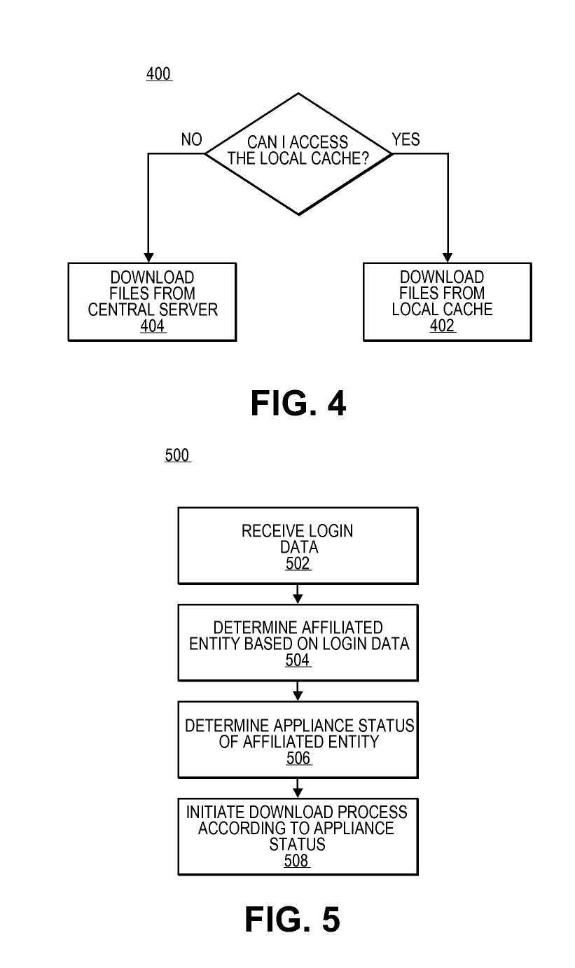

Hence, from a top-level perspective, an embodiment of the invention is demonstrated via flowchart 400 of FIG. 4. If the local cache is accessible, files may be downloaded from the local cache at 402; otherwise, files are downloaded from the central server at 404.

Flowchart 500 of FIG. 5 illustrates a process according to an embodiment of the invention. At step 502, a server device receives login data from a client device. This login data may have been input by a user at the client device, via a web interface which may be hosted on the server. The login information may include, for example, a username and password, or other information. An affiliated entity of the user may then be determined based on the login data, at step 504. For example, the user may be affiliated with an entity such as a school, district, state, business, or other organization. This information may be stored in a database accessible to the server.

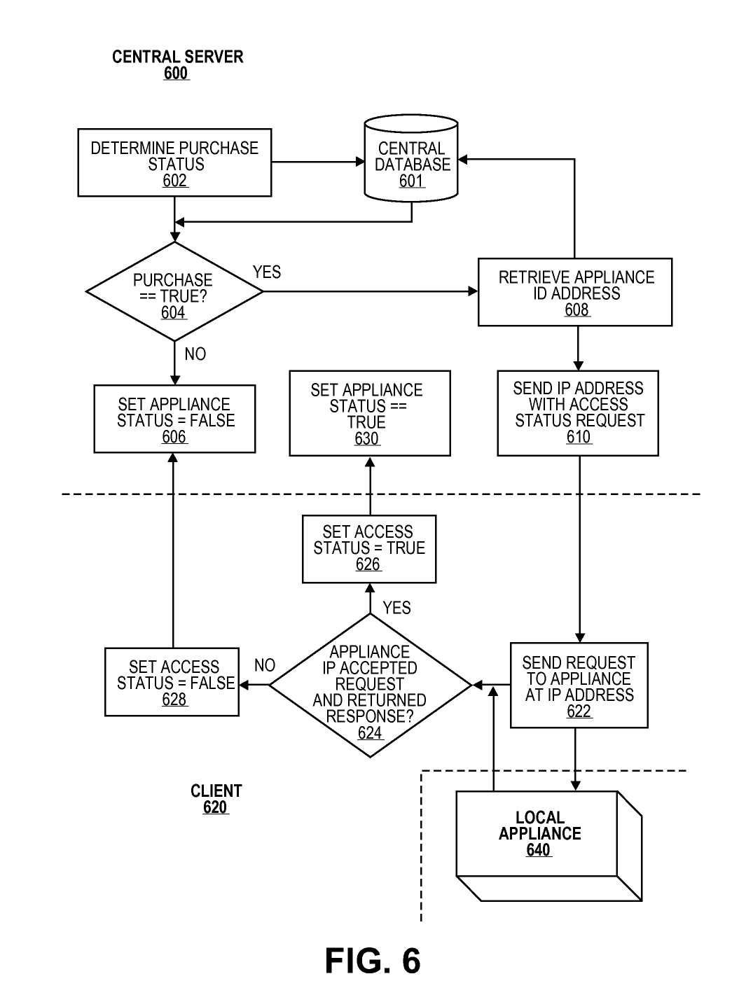

At step 506, an “appliance status” of the affiliated entity may be determined. The appliance status may indicate whether the entity has access to an appliance such as, but not limited to, a local cache. This determination is described in further detail below in reference to FIG. 6. The download process may then be initiated according to the appliance status at step 508. For example, if the appliance status is positive, the server may redirect the download to occur from the appliance; if the appliance status is negative, the download may be directed to occur from the server. The download redirect may occur automatically, such that the user is unaware of where the files are downloaded from. Alternatively, the user may be notified, such as by conditionally changed download links on the web interface, as described with reference to FIG. 2.

FIG. 6 illustrates a process for determining the appliance status of an entity. In making this determination, a purchase status indicating whether the entity has acquired an appliance by, for example, purchase or other arrangement, may first be determined at 602. If no acquired appliance is indicated at 604, the server 600 may set the appliance status with a negative indication at 606.

If it is found at 604, according to a central database 601 or other source, that the entity has in fact acquired an appliance 640, the server 600 may then retrieve the IP address of the appliance 640 at 608. This appliance IP address may be sent at 610 to the client 620 along with a request for an access status to indicate whether the client 610 can successfully access the appliance 640. This may be necessary because the server 600 is unable to determine by itself whether the client 620 can access a local cache 640. Thus, the client 620 at 622 then sends a request to the appliance 640 at the appliance IP address using, for example, client-side JavaScript, to check for accessibility to the appliance 640. If the results of the detection JavaScript indicate that the appliance accepted the request at 624, the client may return a positive access status to the server at 626. Otherwise, the client may return a negative access status to the server at 628. As an example, where the client, such as a teacher's laptop, is within the same local network, such as that of a school campus, as the local appliance, the appliance should accept the client's request and return a response.

Upon receiving a response from the client, the server sets the appliance status accordingly at 606/630. The server may then proceed to initiate the download process from either a server, such as 600, of a data center or the local appliance 640. Access control to files in the data center or the local cache may be managed on the server-side.

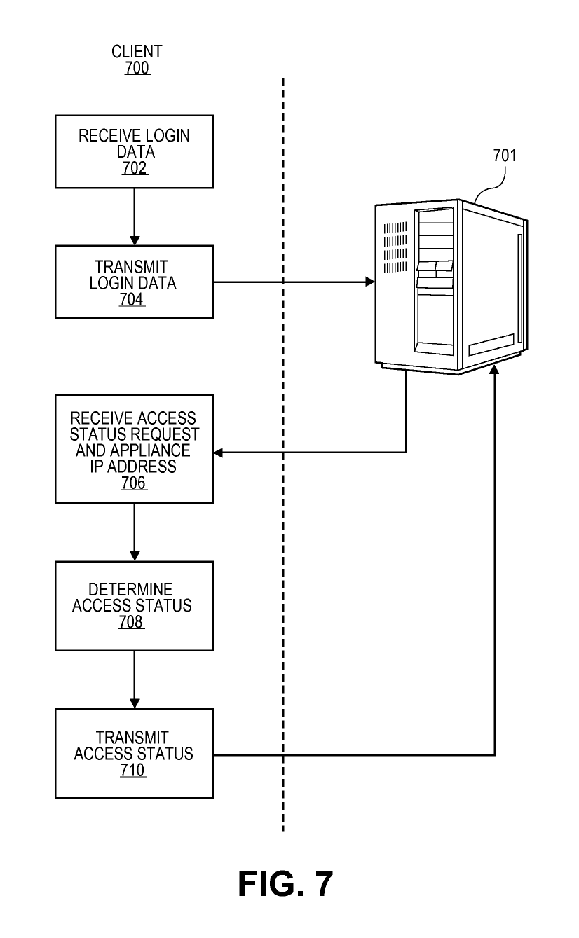

FIG. 7 illustrates a process according to an embodiment of the invention. At step 702, a client device 700 receives login data from a user. The login data is then transmitted to a server device 701 at 704. An access status request is then received from the server along with an appliance IP address at 706. Using the appliance IP address, the access status is determined at 708 according to, for example, the process described above in reference to FIG. 6. The determined access status is then sent to the server 701 at 710.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The methods include a novel approach for conditionally obtaining files from either a local appliance or central server. Although the above embodiments are described and illustrated using the context of a local cache on a school campus, the scope of the invention extends to other applications where such functions are useful. Furthermore, while the foregoing description has been with reference to particular embodiments of the invention, it will be appreciated that these are only illustrative of the invention and that changes may be made to those embodiments without departing from the principles of the invention, the scope of which is defined by the appended claims and their equivalents.

What is claimed is:

1. A method, comprising:
receiving, at a server device, login data from a client device, the login data being input by a user;
determining an affiliated entity of the user based on the login data;
determining an appliance status of the affiliated entity;
initiating a download process according to the appliance status.

2. The method of claim 1, wherein the login data includes a username and password.

3. The method of claim 1, wherein an affiliated entity is chosen from the group consisting of a school, district, state, business, and organization.

4. The method of claim 1, wherein determining the appliance status includes determining a purchase status, the purchase status indicating whether the affiliated entity has acquired an appliance.

5. The method of claim 4, wherein determining the appliance status further includes, if the purchase status indicates that the affiliated entity has acquired an appliance, retrieving an appliance IP address, sending to the client a request, with the appliance IP address, for an access status, and receiving the access status from the client.

6. The method of claim 5, wherein the client sends a request to the appliance at the appliance IP address and returns an access status that is positive if the appliance accepts the request and returns a response.

7. The method of claim 6, wherein the appliance accepts the request and returns a response if the login data is received at a device within a local network, the local network including the appliance.

8. The method of claim 5, wherein determining the appliance status further includes setting the appliance status to indicate availability of the appliance if the access status is positive.

9. The method of claim 1, wherein initiating the download process includes redirecting the user to download from an appliance if the appliance status indicates availability of the appliance.

10. The method of claim 1, wherein initiating the download process includes redirecting the user to download from a central server if the appliance status does not indicate availability of an appliance.

11. The method of claim 1, wherein initiating the download process includes redirecting a download request automatically to an appliance if the appliance status indicates availability of the appliance.

12. The method of claim 1, wherein initiating the download process includes redirecting a download request automatically to a central server if the appliance status does not indicate availability of the appliance.

13. The method of claim 1, wherein initiating the download process includes providing a download link, the appearance of the download link being based on the appliance status.

14. A method, comprising:
receiving, at a client device, login data input by a user;
transmitting the login data to a server device;
receiving from the server a request, with an appliance IP address, for an access status;
determining the access status; and
sending the access status to the server.

15. The method of claim 14, wherein the login data includes a username and password.

16. The method of claim 14, wherein determining the access status includes sending a request to an appliance at the appliance IP address, and setting the access status to a positive indication if the appliance accepts the request and returns a response.

17. The method of claim 16, wherein the appliance accepts the request and returns a response if the login data is received at a device within a local network, the local network including the appliance.
